(19) United States
(12) Patent Application Publication
(10) Pub. No.: US 2009/0121148 A1
(43) Pub. Date: May 14, 2009

(54) High Brightness Solid State Ion Beam Generator, its use, and Method for Making such a Generator

(75) Inventors: Dieter Pohl, Adliswil (CH); Hans-Werner Fink, Zürich (CH); Julien Toquant, Basel (CH); Conrad Escher, Zürich (CH); Sandra Thomann, Zürich (CH); Cornel Andreoli, Zürich (CH)

Correspondence Address: JOYCE VON NATZMER;PEQUIGNOT + MYERS LLC, 200 Madison Avenue, Suite 1901, New York, NY, 10016, US

(73) Assignees: UNIVERSITY OF BASEL, Basel (CH); UNIVERSITY OF ZUERICH, Zuerich (CH)

(21) Appl. No.: 11/909,903

(22) PCT Filed: Mar. 29, 2006
(86) PCT No.: PCT/IB2006/000706

§ 371 Date: Sep. 27, 2007

(30) Foreign Application Priority Data
Mar. 29, 2005 (GB) 0507245.9

(51) Int. Cl. H01J 3/14; H01J 27/00

(52) U.S. Cl. 250/396 R; 313/362.1; 250/423 R; 250/424

(57) ABSTRACT

Ion sources or generators for focused ion beam emission (FIB) applications emitting ion beams into vacuum or a gas are used in industry and research for the characterization and processing of surfaces. With appropriate focusing, such ion beams can be confined to diameters of a few nanometers. The tip of technical FIB generators for producing such focused beams consists of a liquid metal, gallium in general, which tends to fluctuate during operation. This has a negative influence on the stability of the emission current and the focus definition. It is also possible to generate an FIB with solid tips, consisting of a solid metal, but such tips deteriorate rapidly during operation due to erosion of material from the tip apex. The present invention concerns a novel FIB source generating free space ion beams from a solid source but does not exhibit the above-mentioned erosion effect at the apex. The novel FIB generator consists of a combination of two essentially unitary bodies, a solid electrolyte body with a sharp tip and a solid ion reservoir body, both bodies having close contact with each other. The reservoir is made of or contains the same material, in general a metal as the mobile ions. Loss of ions from the electrolyte body due to emission is compensated by an inflow of ions from the reservoir body during operation. This practically preserves electro-neutrality which is a precondition for continuous mode operation. Erosion of the tip of the electrolyte body does not occur since the counter ions form a solid matrix and the emitted ions are replenished during operation.

### FIELD OF THE INVENTION

This invention concerns a solid state ion source or generator suitable for focused ion beam emission (FIB) applications. Ion beams emitted into vacuum or a gas are used in industry and research for the characterization and processing of surfaces. With appropriate focusing, such ion beams can be confined to diameters of a few nanometers.

Focusable ion beams require a point source in the shape of a sharp tip. Commercial FIB tools use liquid gallium (Ga) for that purpose. The gallium floats from a reservoir to the end of a needle where it forms a droplet. A large voltage applied between needle and an extraction electrode generates a high electric field at the tip that deforms the droplet into the shape of a tip and field-ionizes Ga atoms at the apex of that tip. The ions are expelled into a surrounding vacuum which contains means for acceleration, focusing, and deflection. Design and operation of stable liquid ion emitting tips are demanding and mastered by few, highly specialized companies only.

A simple alternative would be the use of sharp solid metallic tips, but such tips tend to erode during operation, whereby the emission current and the focus of the beam deteriorate significantly.

The present invention relates to an FIB source capable of generating free space ion beams from a solid-state body, but does not exhibit the typical erosion effect at the tip. To this, the FIB generator of the present invention basically consists of two essentially unitary bodies, a solid electrolyte, super-ionic conductor body having a sharp tip and a solid ion reservoir body in close contact with each other.

Preferably, the reservoir is made of or contains the same material as the mobile ions. Erosion of the tip of the super-ionic conductor body is avoided by the existence of a solid matrix of counter ions and a continuous ion flux from the reservoir body into the ionic conductor body and the tip. In other words, the erosion is shifted from the tip to the reservoir body which may be made sufficiently large to enable a nearly unlimited production of an ion beam.

### BACKGROUND AND PRIOR ART

As mentioned above, ion beams emitted into vacuum or a gas are used in industry and research for the characterization and processing of surfaces. Several techniques are known for such FIB tools and applications. FIB tools are being used for implanting ions locally into a sample, for cutting away (“milling”) material from a defined area with very small dimensions, for depositing material onto a sample, or for selectively etching a material surface by interaction with (organic) gases introduced into a reaction chamber.

Somewhat more specific, FIB tools are used for site-specific cross-sectioning, for inter-facial microstructure studies, in particular for removing of certain metals or oxides, for editing or modifying semiconductor devices, for preparing site-specific TEM samples, and for grain imaging.

Also, high resolution microscopic images of a surface may be generated, similar to those obtained with an electron microscope (SEM). FIB tools for this latter application, i.e. processing and imaging, are therefore generally named FIB microscopes.

Usual FIB generators provide an ion beam emitted by a source, which beam is limited in its angular spread by a suppressor, accelerated by an extractor, collimated by a first lens and confined another time by an aperture. The source has to be lined up precisely with respect to the beam-shaping elements for optimum performance. Since this alignment procedure usually has to be repeated every time the source is replaced, a source with a long service life and/or integrated, pre-aligned beam-shaping elements has many advantages. The resulting beam is then directed onto a selected spot of the target by means of octupoles, deflectors and further lenses.

Especially for such an FIB microscope, a number of specific requirements must be fulfilled:
Brightness: The FIB source or generator has to provide a strong current of ions per unit source area.
Low divergence: The ions must be emitted at a narrow and constant angle.
Monochromaticity: The ions must be emitted with small energy spread. This is required since the “focal length” of an ion lens depends on the initial energy, i.e. the “color” of the ion. The resulting chromatic aberration leads to a blurred images.

Further desirable features are stability, low cost, compact size, ease of operation and, as mentioned above, long service life of the source.

In many applications it is necessary that the implantation of FIB ions must not jeopardize the planned application of the FIB-treated work piece. In other applications, however, implantation is the very purpose of the FIB process, for instance the formation of optical waveguides with or without light-amplifying properties.

The standard ion source in an FIB generator is a sharp tip made—at least partly—from a conductive material. A voltage in the kV-range applied between the tip and an extraction electrode generates a strong electric field at the tip's apex. For sufficient field strength, ions at the tip surface are field evaporated, i.e. they experience a force strong enough to overcome the binding force to the rest of the tip material and to be expelled in direction of the electric field. The emission is usually restricted to the highly curved tip apex since the field enhancement is proportional to the curvature of the surface. Very bright ion emitters can be generated by minimizing the radius of this apex curvature.

In principle, any conductive sharp tip is suitable for ion emission. Solid metallic tips, however, erode during operation such that the tip becomes more and more blunt. The electric field strength at the apex is correspondingly reduced and so is the emission current. For this reason, tips suitable for operation over extended periods of time must maintain their shape while allowing for a continuous flow of ions to the tip.

The most common FIB generators use a tip formed by a molten metal, gallium (Ga), in general. Gallium has the advantage of a very low melting point and a relatively low level of toxicity. As described by J. Melngailis in “Ion sources for nanofabrication and high resolution lithography”, IEEE Proceedings of the 2001 Particle Accelerator Conference, Chicago 2001, p. 76, molten Ga is pulled from a reservoir along a needle of solid metal towards its apex by the electric field and capillary forces. The droplet of liquid at the apex itself takes on the shape of a sharp tip under the influence of the electric field. This source is fairly stable, bright, has an acceptable energy spread (ΔE˜5 eV), and a long lifetime (˜1000 hours). However, due to the liquid flow condition, there are frequent fluctuations in the emission current. Sources with other metals, e.g. In, and with alloys such as Au/Si, Au/Si/Bi, and Pd/As/B have also been developed but are more difficult to handle and are not as stable or long-lived.

An alternative to the liquid metal source is the gas field ion source. The geometry of such a source is similar to the liquid metal source, except that the needle is cooled to cryogenic temperatures and gaseous species such as H, He, Ne, or Ar are condensed on the needle. Again the ions are extracted by applying a voltage between the tip and a concentric electrode below the tip. With a sharpened tungsten needle tip of a few microns radius, the ion source characteristics are similar to those of the liquid metal source described above. Under particular conditions, it can have an extraordinary brightness, as described by R. Boerret, K. Jousten, K. Boehringer, and S. Kalbitzer in J. Phys. D, Appl. Phys. 21, p. 1835.

However, both sources described above are in general difficult to operate and appear not to have been incorporated into commercial systems to date, as described by J. Melngailis, supra.

A third, and somewhat more promising approach consists in the use of a solid ionic conductor for the FIB generator. One such ion (and atom) source is disclosed in Seidl U.S. Pat. No. 4,783,595, “Solid-state source of ions and atoms”. The Seidl USP shows a source of a beam of positive ions or atoms comprising an ion-emitting pellet consisting essentially of a solid electrolyte.

Preferred solid electrolytes for the pellet are described as being alkali or alkali-earth mordenites. These materials have a room temperature conductivity of <10⁻¹⁰ S/cm⁻¹, cf. Table 1 below and the article by A. N. Pargellis and M. Seidl “Thermionic emission of alkali ions from zeolites”, J. Appl. Phys. 49, 4933 (1978). They are “poor-ionic solids” according to the classification of R. C. Agrawal & R. K. Gupta in the review article “Superionic solids: composite electrolyte phase—an overview” (Journal of Materials Science 34 (1999) 1131-1162). The classification is reproduced in the following table.

TABLE 1

| | | Conductivity at 27° C. |
|---|---|---|
| Materials | | (S/cm) |
| Electronic conductors | Metals | ca. 10⁻⁵ |
| | Semiconductors | ca. 10⁻⁵ to 10⁰ |
| Ionic conductors | Superionic solids | ca. 10⁻¹ to 10⁻⁴ |
| | Normal-ionic solids | ca. 10⁻⁵ to 10⁻¹⁰ |
| | Poor-ionic solids | <10⁻¹⁰ |

Poor ionic solids have a sizeable conductivity at elevated temperatures only. The Seidl USP consequently includes a heater filament that is capable to heat the pellet to a temperature of about 1000° C., at which ions are emitted from the pellet due to field-enhanced thermionic emission. A beam-forming electrode contacts an ion-emitting surface of the pellet, this beam-forming electrode having a passageway extending through it for ions from the ion-emitting surface. The ion-emitting surface of the pellet may be coated with a layer of porous tungsten or another refractory, high-work-function, material to establish an essentially equal potential across the surface and to neutralize ions emitted from the surface when the source is operated as an atom source.

The above-described apparatus may have some advantages over the prior described liquid metal or gas field ion sources, in particular by its use of a solid electrolyte. But since the ion (or atom) beam is emitted from an extended source according to the above Seidl USP, it cannot to be focused. This device hence cannot be called an FIB generator, which latter requires a well focusable ion beam, as explained above. Another serious limiting factor is the use of the high temperature of about 1000° C. which prohibits the use of this device in any temperature-sensitive environment.

Materials that can be emitted in the form of ions by said apparatus are alkali or earth alkali metals. These materials are highly reactive (oxidation, etc.) which can be desirable for certain applications, but will generally be a disadvantage. Furthermore, high currents are obtained in pulsed mode only as described by A. N. Pargellis and M. Seidl in J. Appl. Phys. 49, 4933 (1978) and by J. Matossian and M. Seidl in J. Appl. Phys. 53, 6376 (1982).

Another solid electrolyte source is disclosed in Matossian U.S. Pat. No. 4,994,711, “High brightness solid electrolyte ion source”, showing a solid electrolyte ion source with an emitting tip which is small enough to concentrate an electric field from an extraction plate.

The material used for the solid electrolyte is either Cs mordenite (one of the mordenites also disclosed in the above-cited Seidl USP) or yttrium-doped zirconia which also belongs to the class of poor-ionic solids. Reportedly, the tip shape significantly increases the extracted current density compared to the prior solid electrolyte source. The source was heated to a temperature on the order of 1100° C. (mordenite) and 1850° C. (zirconia), sufficient to induce a thermionic ion emission from the respective tips. The ion emission can be varied independent of the extraction field by varying the degree of heating, thereby reportedly preserving a constant focused ion beam spot size during changes of beam brightness. The tip is said to have a radius in the approximate range of 1-10 μm. Use for ion-microprobe surface analysis and micro-circuit fabrication applications previously unavailable with solid electrolyte sources is contemplated.

Though this appears to be a viable approach fulfilling most of the above-listed requirements, it has three significant disadvantages:
1. The ions are emitted thermionically at temperatures of about 1100° C. and 1850° C., respectively, which prohibits the use of this device in any temperature-sensitive environment.
2. The tip preferentially has a radius of curvature of 1-10 μm. This is too large for a true point source which should have a radius of curvature clearly in the sub-micron regime, preferably around 100 nm or less for strong focusing.
3. The emitted ions are Cs, an alkali metal, and oxygen, respectively. Due to their high chemical reactivity, these materials are undesirable in many applications.

Even more important, it remains uncertain in both the Seidl USP and the Matossian USP how the loss of ions and the resulting imbalance of charge in the source can be compensated over an extended period of time. It is apparently foreseen to replace ionic material emitted from the surface of the source (in the Matossian USP restricted to the tip) by material from the bulk of the source, cf. Matossian USP p. 5, line 42-44. Diffusion of ions from the bulk to the surface indeed can keep the variation in the stochiometry at a low level for a long period of operation but it does not prevent the charging of the source, i.e. loss of electro-neutrality during operation. As a result, the voltage between source and extraction electrode will continuously decrease, accompanied by a corresponding decrease in ion current until the emission process comes to an end.

Such behavior indeed was reported by A. N. Pargellis and M. Seidl in their article “Thermionic emission of alkali ions from zeolites”, J. Appl. Phys. 49, 4933 (1978), see FIG. 2 of this paper. To compensate for this effect during operation, new charges have to be injected at a sufficient rate into the source. This requires an additional mechanism provided neither in the Seidl USP nor in the Matossian USP. Hence it appears questionable whether the two above-discussed ion sources are suitable for extended periods of operation.

The present invention resolves these shortcomings and devises an FIB generator which provides a long-term stable operation of such a generator with regard to brightness, low dispersion, and monochromaticity. Furthermore, it allows for operation at room temperature or slightly above by exploitation of field emission instead of thermionic emission. It also features relatively low cost and compact size and is easily operated.

### THE INVENTION

The invention is based on the novel idea to generate a continuously operable ion source by combining a solid electrolyte with a separate reservoir for the ions. This is achieved by arranging two essentially unitary bodies, a solid-state electrolyte body and a solid ion reservoir body, in close contact. The contact between the two bodies enables transfer of ions in sufficient quantities to avoid ion depletion in the electrolyte body.

The resulting FIB source or generator is solid and still does not erode at its tip during operation, i.e. when generating free space ion beams from the electrolyte body. The FIB source also can be operated in continuous mode since electro-neutrality is pre-served by the inflow of ions from the reservoir, thus avoiding charging during operation.

The electrolyte body is preferentially made from a super-ionic solid and the tip is sufficiently sharp or pointed, i.e. the curvature of its apex is sufficiently small, to enable field emission of ions from the tip at room temperature or slightly above room temperature.

Some general properties of solid electrolytes shall be described in the following. Most solid electrolytes are salts, composed of partially or completely ionized constituents. One of said constituents is loosely localized in the crystal lattice or amorphous network of the residual constituents. The loosely bound constituent is a small metal cation in most of the known solid electrolytes. When such a solid electrolyte is sandwiched between two electrodes and a voltage is applied, the ions migrate from one electrode to the other. In contrast to liquid electrolytes, the residual constituents form a solid matrix that forces the mobile ions to move along fixed migration pathways. The latter probably result from accumulations of vacancies along a path between the two electrodes. Most solid electrolytes accept a certain species of cations only. The ion-emitting electrode, i.e. the anode for metal ions, hence has to consist of the same metal as the ions if a continuous current is to be sustained. Otherwise, the charging effect mentioned above will stop the ionic current after a short period of operation.

Many salts, such as halogenides, phosphates, and chalcogenides are regularly used as solid electrolyte materials. Very often, silver is the mobile cation in these solid electrolytes. Other metals showing electrolytic mobility in the solid state are Li, Na, K, Ca, Cu, Al, and rare earths such as Er, Sc and Y. Ion beam sources made from the respective electrolytes will enlarge the choice of ions available. This will be of particular importance for the local doping of semiconductors. There are also compounds showing anionic conductivity, e.g. for oxygen and fluor at elevated temperatures. Ion beam sources made from such compounds are of particular interest for local surface processing.

Solid electrolytes are classified, cf. Tab. 1 above, according to their room temperature conductivity as superionic (10⁻¹-10⁻⁴ S/cm), normal-ionic (10⁻⁵-10⁻⁹ S/cm), and poor-ionic (≦10⁻¹⁰ S/cm). Only the first group can sustain a current sufficiently large for room temperature FIB operation which requires beam currents of at least 1-10 μA.

Among the known solid electrolytes (SEs), the highest room temperature conductivities are achieved by silver and copper halides, phosphates and mixtures thereof. For the experiments which led to the present invention, a-AgPO3:AgI (API), an amorphous SE was chosen. It has one of the highest known ionic conductivities at room temperature, is stable at ambient conditions over a long time and can be fabricated conveniently in different shapes.

Erosion of the tip of the electrolyte body is compensated by a continuous ion flux from the reservoir body into the electrolyte body which has the shape of a sharply pointed tip. The tip's apex may have a conical, pyramidal, or irregular shape, as will be understood by someone skilled in the art. Important is that, as mentioned above, the curvature of the apex is sufficiently small to enable field emission of ions at approximate room temperature.

When mounted in an ion beam generator, ions are field-emitted from the apex of the tip upon application of an extraction voltage in the range of 5-20 kV. They are replenished by migrating ions from the electrolyte body so that no erosion takes place at the apex and the tip preserves its shape during operation.

In the present invention, size and shape of the first of the unitary bodies, the electrolyte body, can be selected to achieve the best possible tip structure and shape, independent of any other requirements regarding volume, shape, or similar properties. This is possible because the bulk of the electrolyte body must only compensate for the ions emitted from the tip—it has no reservoir function apart from that, i.e. there is no need to provide ions to the tip from the bulk for an extended period of operation. The tip must just be replenished with ions and the electrolyte body must have a shape appropriate to allow for the necessary throughput of ions. A concave short cone, for instance, is a favourable shape, a long thin fibre an unfavourable one.

The ions required for operation over an extended period of time are provided by the second of the unitary bodies, the reservoir body, which may be made of or contain the material constituting the mobile ions, preferably a metal. Since it serves no other purpose it can be made sufficiently large, in any shape, and from any material that serves this single purpose best.

To provide the necessary flux of ions from the reservoir body to the electrolyte body, the two bodies must be in sufficiently close contact, preferably pressed against each other with adequate force to achieve a low contact resistance that allows transfer of enough ions from the reservoir body to the electrolyte body.

The invention also includes a new use for such a two-bodied FIB generator, referring in particular to its use at room temperatures.

A method for making a two-bodied FIB generator according to the invention is a further aspect, focusing on pulling a thin fiber from a melt close to its solidification temperature, thereby creating a front tip with the desired small apex.

The basic principle and details of the invention shall be explained in the following.

### BRIEF DESCRIPTION OF THE DRAWINGS

Various examples and modifications for carrying out and using the invention shall be explained together with the drawings. These show in

FIG. 1 a schematic illustration of the principle of the present invention;

FIG. 2 a first embodiment of the invention;

FIG. 3 a second embodiment of the invention;

FIG. 4 a third embodiment of the invention;

FIG. 5 a fourth embodiment of the invention; and

FIGS. 6a-6d an exemplary manufacturing method for an FIB tip.

### DETAILED DESCRIPTION OF SEVERAL EXEMPLARY EMBODIMENTS

Several implementations of the invention are disclosed in the following. They differ in shape and arrangement of the two bodies, the solid electrolyte body and the reservoir body. However, the same reference numbers in the drawings always refer to the same functional parts of the different embodiments, though they sometimes look very different.

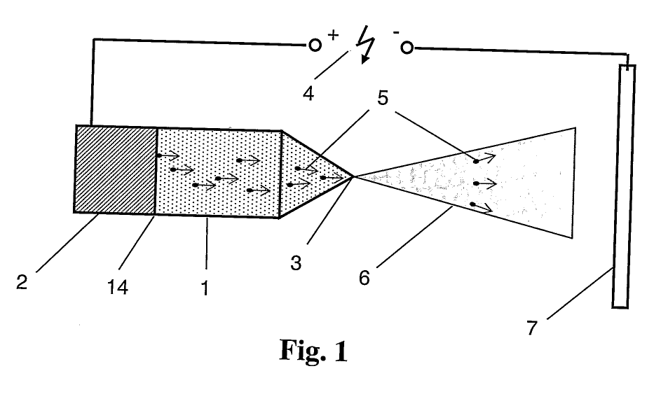

FIG. 1 shows the principle of FIB source according to the invention, namely the combination of a solid electrolyte body 1 and an ion reservoir body 2. The pointed tip 3 of the is electrolyte body is placed opposite an extraction electrode 7. The tip 3 may possess a conical, pyramidal, or irregular shape, important is the curvature at its apex. In such an ion beam generator, ions 5 are field-evaporated from the apex of the tip 3. These ions are replenished by migration from the ion reservoir 2 through the bulk of electrolyte body 1 to the tip. This avoids excessive charging of the electrolyte body as well as erosion at the apex of the tip. The curvature of tip 3 must be kept sufficiently small to allow emission 6 of ions 5 at normal temperature, i.e. at room temperature, or somewhat above, e.g. up to 300° C., with a voltage in the kV range, for instance 15 . . . 20 kV between ion reservoir 2 and extraction electrode 7.

The voltage is generated by high voltage source 4 and generates an electric field essentially between the tip 3 of the electrolyte body 1 and the extraction electrode 7. To avoid depletion of ions 5 in the electrolyte body 1, ion reservoir 2 provides ions of the same kind as those emitted from the tip 3 in sufficient quantities to the electrolyte body. This is done by appropriately selecting the material of the reservoir body 2 and by providing an interface or contact area 14 of sufficient conductivity, i.e. with low resistivity, between the reservoir body 2 and the electrolyte body 1. By shaping this interface 14 suitably and by pressing the two bodies against each other, the resistivity can be kept low enough to enable easy migration of the ions from the reservoir body 2 to the electrolyte body 1. The process of erosion, which usually takes place at the tip 3, is thus shifted to the reservoir body 2 where it can be compensated for an extended period of operation.

Preferred electrolyte materials are super-ionic conductors whose conductivity is large enough to allow for a sufficiently large current through the electrolyte body at room temperature or slightly above (<300° C.). Sufficiently large here means currents required for FIB processing, at least 1 μA, but preferentially >10 μA. A particularly favourable material is API (Ag₄IPo₄) for the electrolyte body 1 and silver (Ag) for the reservoir body 2, but other suitable materials and material combinations may be chosen. Examples for providing the desired metal ions are Li, Na, K, Ca, Cu, Al, and rare earths such Se and Y, mentioned above and described in the literature. Other examples for the electrolyte body 1 are Li-, Na, and K-doped β-aluminas, mixed bromides such as C₆H₁₂N_{2.2}HBr—CuBr (87.5 m), Ca₂P₂O₇, and tungstates of the type R₂(WO₄)₃ with R═Al, Sc, Y, and Er. Extensive tables of solid electrolytes may be found in the literature, especially in the above-cited review article by R. C. Agrawal and R. K. Gupta.

As mentioned above, API (Ag₄IPo₄) was chosen for the electrolyte body 1 and silver (Ag) for the reservoir body 2. The reason is that among the known silver halides, phosphates and mixtures thereof are among the super-ionic conductors with the highest conductivity. API, an amorphous solid electrolyte, was chosen because it has one of the highest known ionic conductivities at room temperature, is stable at ambient conditions over a long time and can be fabricated conveniently in different shapes.

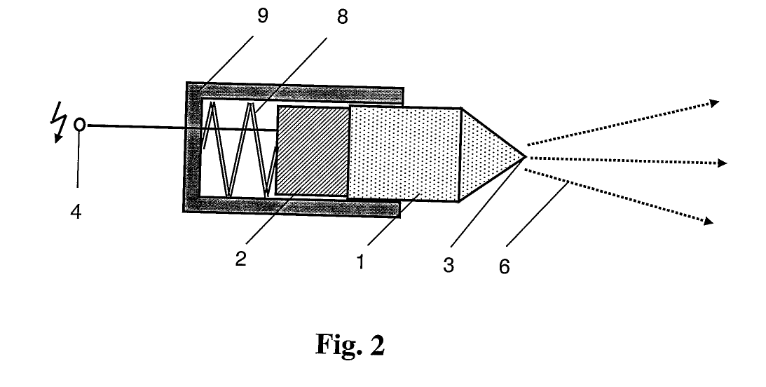

FIG. 2 shows a first practical embodiment of the invention. As in FIG. 1, a combination of ion reservoir 2 and solid electrolyte body 1 with its pointed tip 3 is placed opposite an extraction electrode (not shown in this figure), emitting an ion beam 6 which is field-evaporated from the apex of the tip 3. The ions are replenished by migration of ions from the reservoir body 2 to the bulk of the electrolyte body 1 and from there to the tip 3. A high voltage source 4 is connected with its positive pole to the reservoir body 2 and with its negative pole to a (not shown) extraction electrode, equivalent to the extraction electrode shown in FIG. 1.

A casing 9 from isolating material holds the electrolyte body 1, the reservoir body 2, and a spring 8 pressing the two bodies against each other. Regarding the transfer of a sufficient number of metal cations from the reservoir body 2 to the tip 3, the following considerations are being made.

In an FIB source according to the invention, the process of erosion during ion beam emission from the tip 3 is shifted to the reservoir body 2 via the interface between the electrolyte body and the reservoir body. The continuous abrasion of metal, silver in the present example, from the reservoir body 2 would break the contact to the solid electrolyte 1 after a while if this was not prevented by appropriate measures.

The most straightforward measure is the generation of a large contact area between the electrolyte body and the reservoir body. For example, a monolayer of silver with an area of 1 mm² can supply a 1 μA ion beam for about 10 days. Further increase of the contact area, for instance by the formation of a rough and/or otherwise non-planar interface may increase the contact lifetime accordingly.

A better solution for the contact problem is the exertion of mechanical force between the electrolyte body and the reservoir body, for instance by spring-loading one against the other. Various spring-loaded embodiments are shown in FIGS. 2, 3, and 4. Note that electrolyte body and the reservoir body need not be in perfect contact at the beginning of the operation since the erosion preferentially abrades the points of contact which results in an increasingly intimate contact between the two bodies.

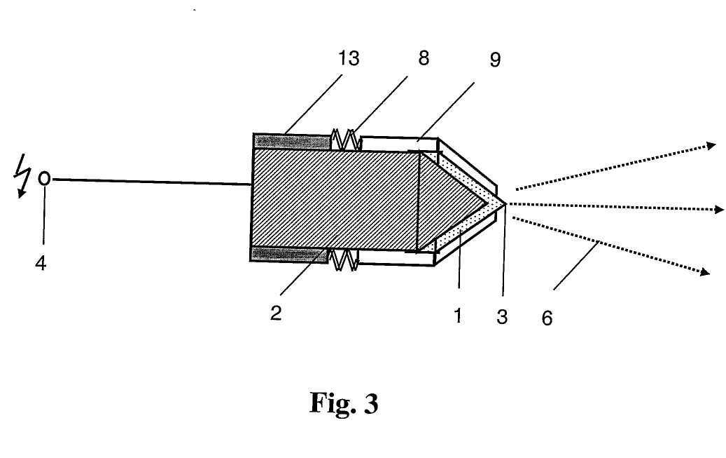

FIG. 3 shows a second embodiment of the invention, displaying again, as in FIGS. 1 and 2, a combination of ion reservoir 2 and solid electrolyte body 1 with its pointed tip 3 and an ion beam 6 field-emitted from the apex of the tip 3. A high voltage 4 source is connected with its positive pole to the reservoir body 2 and with its negative pole to a not shown extraction electrode. The solid electrolyte body 1 has the shape of a relatively thin hollow cone with a pointed front end whose inner surface matches the front end of the reservoir body 2 which is essentially a round cone.

A front casing 9, relocatably holding the front end of the reservoir body 2 and the electrolyte body 1, is connected to a rear casing 13 by one or more tension springs 8. The rear casing 13 is fixed to the rear part of the reservoir body 2, thus pressing the latter into the inner surface of the electrolyte body 1.

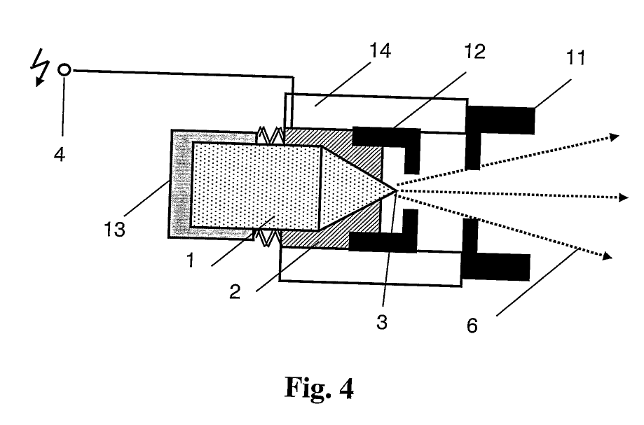

Minimizing the spot of emission is a requirement for strong focusing of an FIB, desired in most applications. Emission from several spots or from a large one is not desirable. Selection of a single spot can be achieved by using very sharply pointed probes and/or installing a small aperture in the path of the ion beam. The latter may be achieved by covering the tip with an isolating, emission-suppressing casing everywhere except for a very small opening at the apex. Openings with a diameter as small as 30 nm, possibly even less at tip apices, can be formed by electrolytic erosion, plastic deformation or FIB processing. An alternative is the use of a micropipette or a similar device filled with the solid electrolyte, as described further down. An example for an embodiment employing some measures along these lines is illustrated in FIG. 4.

FIG. 4 shows a somewhat more complex third embodiment of the invention. Again, a combination of ion reservoir 2 and solid electrolyte body 1 with its pointed tip 3 emits an ion beam 6 from the tip's apex. Dissimilar to the previously described embodiments, the reservoir body 2 here envelops the electrolyte body 1 and, at the same time, provides the holding means for the latter. For that, the reservoir body 2 has an inner conical surface matching the outside cone of the electrolyte body 1, with an opening for the tip 3.

An isolating front casing 14 provides a holding means for the reservoir body 2 and for one or more beam focusing means. Shown in FIG. 4 are a suppressor 12, electrically connected to the positive pole of the high voltage source 4, and an extractor 11 connected to the negative pole, but the number and arrangement of such beam shaping means depends on the desired form of the ion beam 6. A rear casing 13 is fixed to the electrolyte body 1 and, by means of tension springs, presses the latter into the inner conical surface of the reservoir body 2.

Depending on the intended use of an FIB source, comparatively large ion currents may be required. It was found that the ion current may be maximized by avoiding or reducing the limitation created by the diffusion of ions from the electrolyte body or reservoir to the emission point, i.e. the tip. Hence the ion beam current may be maximized by

(1) choosing a material with inherently high conductivity, i.e. a super-ionic conductor (such as API), and/or
(2) minimizing the ion current path length between ion reservoir and emission point, and/or
(3) raising the temperature of the electrolyte body which increases the mobility of the ions and hence the ionic conductivity.

It should be clear from the above, that an embodiment according to FIG. 4 provides good solutions for each of the first two maximization possibilities above, i.e. choosing an effective material, here API, and minimizing the diffusion lengths between reservoir and tip.

Focusing onto the third possibility, the solid electrolyte/reservoir assembly can be combined with heating elements, of course with or without beam-shaping members as shown in FIG. 4, into one integrated device.

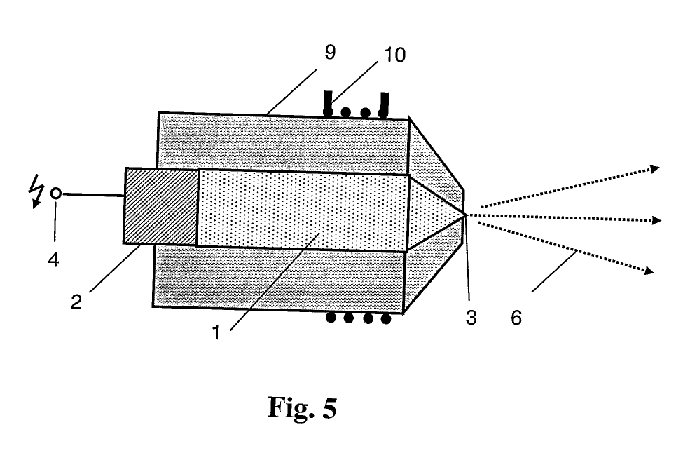

FIG. 5 shows in a fourth embodiment a device with heating or cooling means. The arrangement is somewhat similar to the first embodiment shown in FIG. 2.

A unitary isolating casing 9, for instance a glass tube in the shape of a micro-pipette, envelops the combination of reservoir body 2 and the electrolyte body 1, leaving a small opening for the tip of the latter, from which tip 3 the ion beam is emitted. The spring means for pressing the two bodies together is not shown. The casing 9 carries heating means 10, shown as several windings of a preferably electrically heated wire or a radiator coil.

The embodiment allows for heating up to a few hundred ° C., e.g. up to 300° C. This is sufficient for many super-ionic conductors to raise the conductivity into the required range. 300° C. is a fraction only of the temperatures required for thermionic emission from a poor-ionic conductor, typically above 1000° C., even up to 1850° C., as described in the above-cited prior art.

For certain applications, cooling of the FIB source can be of advantage. Cooling reduces the thermal spread of the velocities of the individual ions—the beam becomes more “monochromatic”. This results in a better focusing capability since the electro-static and magnetic lenses used in FIB tools suffer from large chromatic aberrations quite generally. Improved focusing is of particular interest for imaging with FIB and implantation of ions into minimum size volumes. Cooling of the FIB source can be achieved with essentially the embodiment of FIG. 5 by replacing the heater coil by a cooling element, e.g. a liquid nitrogen filled outer tube or a Peltier element.

A different issue with regard to FIB sources is the necessary shaping of the tips of the electrolyte body. A sharp tip is mandatory for high brilliance in field emission, and it is also required for the formation of a sharp focus. This can be understood by the analogy between particle beams and light beams: The size of a focused spot is proportional to the spot size of the source as long as the wavelength is small compared to that spot. The quantum mechanical wavelength of the ions used in typical FIB applications is in the range of sub-angstroms, hence irrelevant for most applications.

Several inventive methods may be applied to create the tips of any of the above-described FIB sources, especially when using API, the preferred material for the electrolyte body.

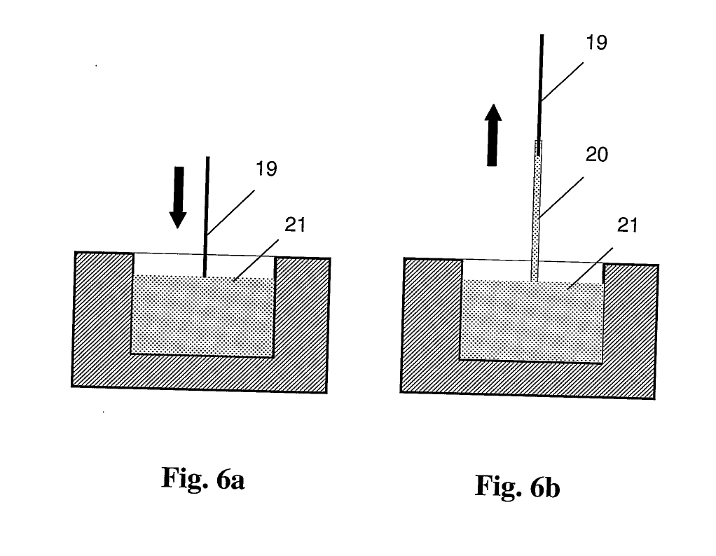

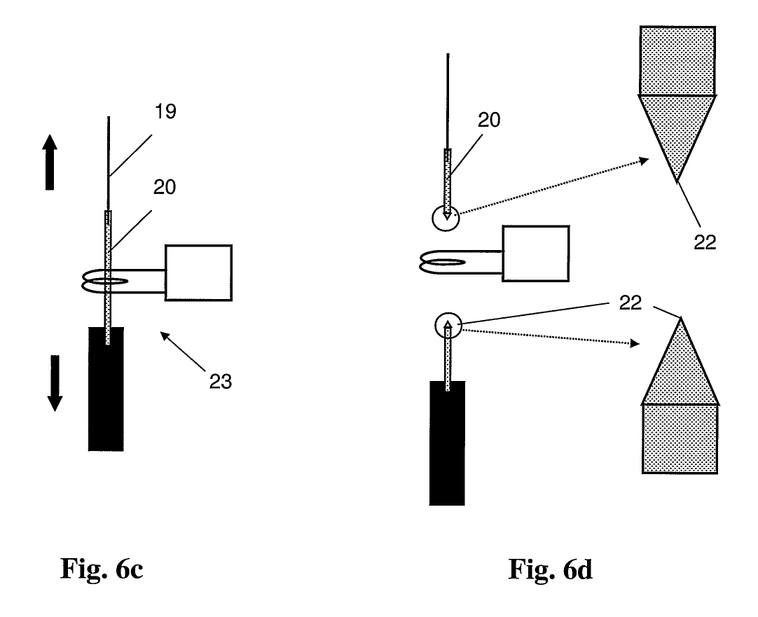

In a first method, illustrated in FIGS. 6a and 6b, a thin API fiber is produced by pulling a fiber 20 from an API melt 21 near the melt's solidification temperature, about 300° C., with an appropriate tool 19. A sharp tip 22 at the end of such a fiber 20 may be generated with a modified micro-pipette puller 23, shown schematically in FIGS. 6c and 6d. Such a fiber tip 22 provides stable currents at least in the nA range. As shortcoming, fiber tips sometimes may undergo mechanical rupture under the influence of electric fields generated at the tip.

In a second method (not shown in the drawings), the API is encapsulated inside a glass pipette. The pipette is stretched and narrowed with a micro-pipette puller to form an opening in the sub-micron range at one end. The pipette provides a stiff isolating mantle around the electrolyte that prevents rupture of the brittle material. In addition, it allows for in-situ heating by means of an electrically heated wire or a radiator coil attached to the pipette. This leads to a stable source that delivers currents in the μA range. The embodiments shown in FIGS. 3 and 5 are examples for the application of an FIB source made according to this method.

In a third method, sharp tips are obtained by cleaving a piece of API in such a way that three faces are formed which meet at a sharp apex. Tetrahedral tips made from regular glass slides with atomically sharp apices are reported in the literature, e.g. by J. Koglin, U. C. Fischer, and H. Fuchs, Phys. Rev. B 55, 7977 (1997), and by A. Naber et al., Phys. Rev. Lett. 89, 210801 (2002). Cleaving of amorphous API according to the same or a similar method will provide similar results.

A fourth method is based on the use of a FIB microscope. Tips prefabricated by one of the previous methods (or any other method) can be sharpened and/or given a desired shape in the nanometer range. The method and techniques used for the purpose are well known to any person trained in the use a FIB microscope.

The invention has been described using some detailed and some exemplary preferred embodiments. However, it is to be understood that the scope of the invention is not limited to the disclosed embodiments and that other applications and modifications of the invention by a person skilled in the art are encompassed by the following claims.

1. A focused ion beam (FIB) generator with a solid electrolyte and an electric field adapted to create a focused beam of mobile ions comprising
a unitary solid electrolyte body comprising a non-eroding first material and having a front tip with an apex of predetermined curvature, from which front tip said focused beam of mobile ions exits and
a unitary solid reservoir body of a second material contacting said electrolyte body, said reservoir body comprising material suitable to forward mobile ions to said solid electrolyte body.

2. The FIB generator according to claim 1, wherein the electrolyte body is held in a predetermined position and has a transfer surface remote from its front tip, the reservoir body being in close contact with said transfer surface, thus allowing essentially continuous transfer of ions from said reservoir body to said electrolyte body.

3. The FIB generator according to claim 2, wherein the transfer surface of the electrolyte body is a rear surface essentially opposite of the tip of said body.

4. The FIB generator according to claim 2, wherein the transfer surface of the electrolyte body is essentially flat, as is the corresponding transfer surface of the reservoir body.

5. The FIB generator according to claim 2, wherein the electrolyte body is essentially a cone-shaped shell whose inner surface is a close contact with a cone-shaped reservoir body to enable the desired ion transfer.

6. The FIB generator according to claim 2, wherein the reservoir body is in close contact and at least partly envelops the electrolyte body, leaving the front tip of said electrolyte body free.

7. The FIB generator according to claim 2, wherein
the reservoir body is a shell whose inner surface is essentially cone-shaped and
the electrolyte body has a similarly cone-shaped outer surface in close contact with said reservoir body's inner surface.

8. The FIB generator according to claim 1, wherein
the close contact between the electrolyte body and the reservoir body is provided by an appropriately arranged resilient member.

9. The FIB generator according to claim 1, further including a heater for warming at least the region of the front tip of the electrolyte body above ambient temperature, in particular to a temperature of no more than about 300° C.

10. The FIB generator according to claim 1, further including a cooling apparatus capable of reducing the temperature of at least the region of the front tip of the electrolyte body below ambient temperature.

11. The FIB generator according to claim 1, further including
a casing, especially an isolating casing, said casing providing a fixed support for either the electrolyte body or the reservoir body and a spring-loaded support for the corresponding other body.

12. The FIB generator according to claim 11, wherein the casing is in two parts, spring-loaded against each other, one part holding the electrolyte body, the other part holding the reservoir body.

13. The FIB generator according to claim 11, further including ion beam extraction means and, preferably, suppression and/or focusing means, in particular an extraction electrode and a suppression electrode fixed to one part of the casing in the vicinity of the front tip of the electrolyte body.

14. The FIB generator according to claim 1, further including a high voltage contact directly connected to the reservoir body.

15. The FIB generator according to claim 1, wherein
the first material is a halogenide, especially silver halide, or a phosphate, especially silver phosphate, or a chalcogenide or a mixture thereof, in particular amorphous API, and the second material is a metal, in particular silver.

16. The FIB generator according to claim 1, wherein
the mobile ion is a cation, especially Ag⁺, Li⁺, Na⁺, K⁺, Ca²⁺, Cu⁺, Al³⁺,
or a rare earth metal ion.

17. The FIB generator according to claim 1, wherein the mobile ion is an anion, especially O²⁻ or F⁻.

18. A method for creating a focused beam of mobile ions comprising:
providing the FIB generator according to claim 1, wherein
the electrolyte body, especially the tip of said body, is kept at room temperature.

19. A method for creating a focused beam of mobile ions comprising:
providing the FIB generator of claim 1, wherein
the electrolyte body, especially the tip of said body, is heated to a temperature above ambient temperature, especially to a temperature of less than about 300° C.

20. A method for creating a focused beam of mobile ions comprising:
providing the FIB generator of claim 1, wherein
the electrolyte body, especially the tip of said body, is cooled to a temperature below ambient temperature.

21. A method for making an FIB generator according to claim 1, comprising
providing a melt of the first material, especially API, having a temperature near its solidification temperature,
pulling a thin fiber from said melt, and
tearing said thin fiber apart in a micropipette puller, the ends of the broken fiber providing the front tip of the electrolyte body with the desired apex.

22. A method for making an FIB generator according to claim 1, wherein
the apex of the front tip of the solid electrolyte body is generated by cleaving or cutting a piece of solid electrolyte material.
